(19) United States
(12) Patent Application Publication
(10) Pub. No.: US 2008/0111318 A1
(43) Pub. Date: May 15, 2008

(54) Perfect shaft seal

(76) Inventor: Yoshioki Tomoyasu, Fujisawa-shi (JP)

Correspondence Address: Yoshioki Tomoyasu;21-22, Mirokuji 3-chome, Kanagawa-ken, Fujisawa-shi, 251-0016, omitted

(21) Appl. No.: 11/595,912

(22) Filed: Nov. 13, 2006

(51) Int. Cl. F16J 15/14

(52) U.S. Cl. 277/590

(57) ABSTRACT

The invention is directed to develop for the high capable of shaft seals by means of applying rubber bushing which is fixed on the shaft in co-rotating operation and is kept in touch with the opening of the housing with the elastic cover sustained with plastic stuff such as grease filled up in the half round ditch caved on the oblique line of the cylindrical trapezoid bushing at the opposite side in the inside view.

### FIELD OF THE INVENTION

The present invention is generally directed to developing for the high sealing capacity of the shaft in rolling operation tightly against the leakage of the substance such as fluid packed in the inner space of the machine through the gap with the high capacity in simple design.

### BACKGROUND OF THE INVENTION

The present competent either oil seals or shaft seals suffer from low sealing capacity of fluids leaked out through the shaft in rolling operation despite of being very complicated design at high costs. Accordingly,further reliable shaft seals are required for being developed for the driving machines as well as devices from safety point of view.

### DESCRIPTION OF THE PRIOR ART

The torque pressurized on the elastic materials of the conventional seals biased by the displacement of the axis of the rotating shaft of the devices such as the motor, the pump, the engine and the like at the start as well as the stop of the operation is apt to be increased the friction force against either wall or plate thereof, thus eventually entail heavy energy consumption and cause the leakage of the fluids packed inside of the housing.

### SUMMARY OF THE INVENTION

The present invention is directed to develop for the advanced seals superior to the conventional seals in sealing capacity as well as simple design with lower costs by means of applying the rubber bushing in the form of a cylindrical trapezoid processed a half round ring on its oblique line in the side view to be filled up with the stuff such as grease, oils and the like covered with sealing substances such as rubber sheet to be kept in touch with the wall of the opening of the housing on the outside thereof possible to make equal pressure on said wall of the housing at the displacement of said shaft seals at the start as well as the stop in the rotating operation and with a little shorter diameter of the cylinder inside said rubber bushing than that of the shaft involved thus to be spread out by said rotating shaft to be fixed thereon to prevent any fluids from being leaked through said rotating shaft.

### BRIEF DESCRIPTION OF THE DRAWINGS

FIG. 1: One example of the side view of the perfect shaft seals applied to the rotating shaft.

### DETAILED DESCRIPTION OF THE INVENTION

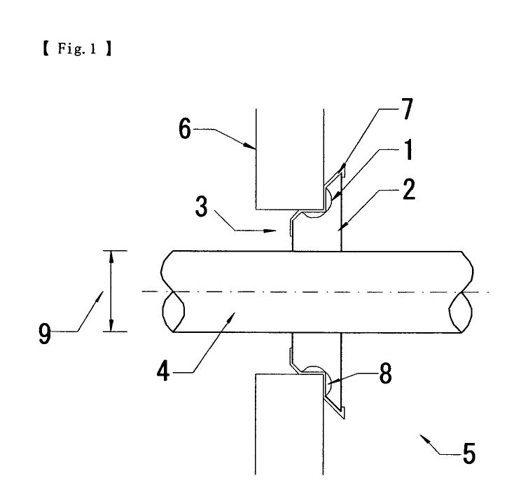

As shown FIG. 1, the present invention is directed to developing for the high sealing capacity of the shaft seal by means of applying the cylindrical trapezoid rubber bushing(2) to be fixed on the rotating shaft(4) in collaboration with the rotating operation by the method of spreading out its shorter diameter than that(9) of the rotating shaft, thus preventing from any leakage of the fluid inside of the housing (5). On the other hand, the opposite side of said cylindrical trapezoid bushing(2) is caved in the shape of a half round ditch processed ring(1), of which inside space is filled with plastic stuff such as grease on the oblique line in the side view coated with an elastic cover(7) to be directly kept in touch with the housing wall(6)consistently in the rotating operation to allow sealing any leakage of the fluid from the housing opening(3) irrespective of the rotating speed thereof from the mechanism point of view.

Therefore, the present invention is designed to allow to follow with the movement of the rotating shaft (4) due to the vibration at the starting as well as the stopping operation by the method that the plastic stuff(8) is flexible enough to move to keep the elastic cover(7) standing closely in contact with the housing wall(6), thus enable to save the consumption in almost half as much as those of the conventional seals such as oil seals and mechanical seals which are impelled to be biased the displacement of the axis of the rotating shaft at the starting or the stopping operation directing to compress the elastic element partially to an extent that the friction against either wall (6) or shaft (4) cause to increase the energy consumption in rotating operation.

1. Shaft Seals is designed to seal the fluids through the gap between either elastic or plain sheet covering the stuff such as grease packed in the ditch caved on the oblique of the outside surface of the cylindrical trapezoid of the bushing in the side view and the opening wall of the housing of the devices such as motors, pumps and the like and between the inside wall of said bushing and the rotating shaft by means of being fixed on the surface to co-rotate in the rotating operation.

2. Shaft Seals is designed to save the energy in rotating operation by means of compressing the bushing through the covering sheet equally lest the biased force at the start of the rotating operation should be put onto the wall of said bushing where it is liable to increase the friction loss particularly.

3. Shaft Seals is designed to easily fit to instal on said device by means of pressing the smaller diameter of the inside cylinder of said bushing in the rotating shaft and the edge of said opening wall of the housing on said stuff through the cover to be kept touch in being pulled.
